(19) United States
(12) Patent Application Publication
(10) Pub. No.: US 2010/0172510 A1
(43) Pub. Date: Jul. 8, 2010

(54) Adaptive noise cancelling

(75) Inventor: Anssi M. Juvonen, Helsinki (FI)

Correspondence Address: DITTHAVONG MORI & STEINER, P.C., 918 Prince Street, Alexandria, VA, 22314, US

(73) Assignee: Nokia Corporation

(21) Appl. No.: 12/319,184

(22) Filed: Jan. 2, 2009

(51) Int. Cl. G10K 11/16

(52) U.S. Cl. 381/71.6; 381/71.1

(57) ABSTRACT

Disclosed herein is an apparatus. The apparatus includes electronic circuitry and a noise cancelling system. The noise cancelling system is connected to the electronic circuitry. The noise cancelling system includes a positioning interface. The noise cancelling system is configured to provide a noise cancelling signal based on, at least partially, the positioning interface.

### BACKGROUND

1. Field of the Invention

The invention relates to ambient noise cancelling and, more particularly, to adaptive/active noise cancelling of ambient noise.

2. Brief Description of Prior Developments

Conventional noise canceling techniques typically provide ambient noise reduction for continuous and/or repetitive types of sounds, such as engine noise in an aircraft cabin for example. However, conventional noise cancelling techniques are generally limited and may not effectively cancel other types of ambient noises.

Cars and other vehicles may present characteristic interior (ambient) noise that may vary depending on various factors such as, motor type, tires, and road segment (pavement, speed limit), for example. Additionally, other indoor/outdoor locations may provide ambient noise environments which can vary based on weather, movement/travel, time of day, or time of year, for example.

As consumers demand increased product and/or component functionality, there is a need to provide configurations having increased capabilities and improved noise cancelling configurations.

### SUMMARY

In accordance with one aspect of the invention, an apparatus is disclosed. The apparatus includes electronic circuitry and a noise cancelling system. The noise cancelling system is connected to the electronic circuitry. The noise cancelling system includes a positioning interface. The noise cancelling system is configured to provide a noise cancelling signal based on, at least partially, the positioning interface.

In accordance with another aspect of the invention, a method is disclosed. An ambient sound signal is received by a microphone. A context-based noise information is received. A noise profile is generated based on the context-based noise information. A noise cancelling signal is computed based, at least in part, on the ambient sound signal and the noise profile.

In accordance with another aspect of the invention, a method is disclosed. A position signal is received. A noise reduction profile is generated based on the position signal. The noise reduction profile is sent to a noise cancelling system of a device.

In accordance with another aspect of the invention, a program storage device readable by a machine, tangibly embodying a program of instructions executable by the machine for performing operations to adaptively reduce noise is disclosed. A position signal is received. A noise reduction profile is generated based on the position signal. The noise reduction profile is sent to a noise cancelling system.

### BRIEF DESCRIPTION OF THE DRAWINGS

The foregoing aspects and other features of the invention are explained in the following description, taken in connection with the accompanying drawings, wherein:

FIG. 1 is a perspective view of an electronic device incorporating features of the invention;

FIG. 2 is a graphical view of a waveform produced by a noise cancelling system of the device shown in FIG. 1;

FIG. 3 is a graphical view of a phase cancellation of ambient noise with the waveform shown in FIG. 2;

FIG. 4 is a perspective view of an electronic device and headset incorporating features of the invention;

FIG. 5 is a perspective view of a vehicle incorporating features of the invention;

FIG. 6 is a perspective of the vehicle shown in FIG. 5 and a diagram illustration of a route with associated metadata;

FIG. 7 is a block diagram of an exemplary method incorporating features of the invention;

FIG. 8 is a block diagram of another exemplary method incorporating features of the invention; and

FIG. 9 is a schematic drawing illustrating components of devices/vehicle shown in FIGS. 1, 4, and 5.

### DETAILED DESCRIPTION

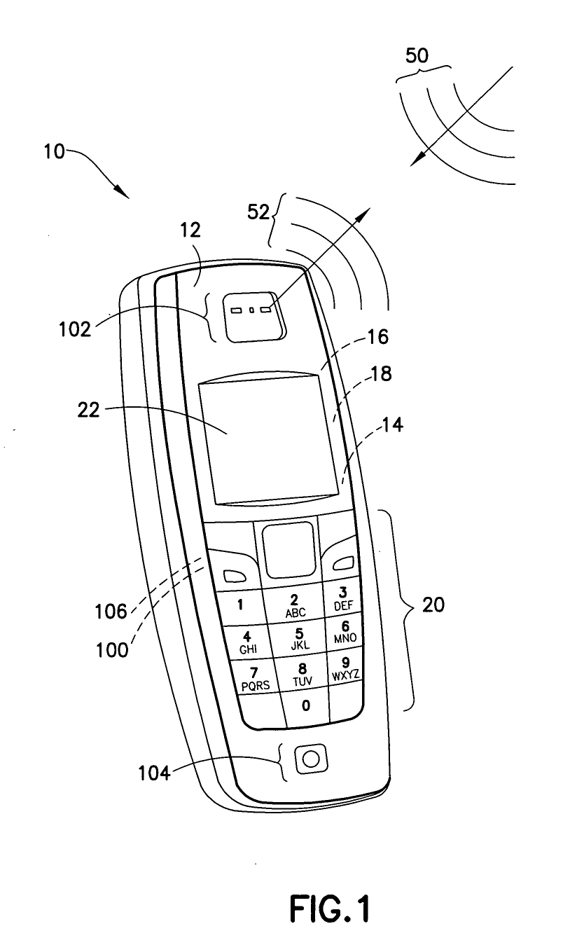

Referring to FIG. 1, there is shown a perspective view of an electronic device 10 incorporating features of the invention. Although the invention will be described with reference to the exemplary embodiments shown in the drawings, it should be understood that the invention can be embodied in many alternate forms of embodiments. In addition, any suitable size, shape or type of elements or materials could be used.

According to one example of the invention shown in FIG. 1, the device 10 is a multi-function portable electronic device. However, in alternate embodiments, features of the various embodiments of the invention could be used in any suitable type of portable electronic device such as a mobile phone, a gaming device, a music player, a notebook computer, or a PDA, for example. In addition, as is known in the art, the device 10 can include multiple features or applications such as a camera, a music player, a game player, or an Internet browser, for example. The device 10 generally comprises a housing 12, a transceiver 14 connected to an antenna 16, electronic circuitry 18, such as a controller and a memory for example, within the housing 12, a user input region 20 and a display 22. The display 22 could also form a user input section, such as a touch screen. It should be noted that in alternate embodiments, the device 10 can have any suitable type of features as known in the art.

It should be noted that the controller may be a computer or a data processor, for example, wherein the data processor comprises a programmable processor with digital signal processing (DSP) capacity. Additionally, the memory may comprise a computer-readable memory medium embodied as a memory that stores a program of computer instructions. Further, the transceiver may be configured for bidirectional wireless communications with a network via the antenna. However, these are merely presented as non-limiting examples and any suitable device configuration may be provided.

The electronic device further comprises a noise cancelling system 100. The noise cancelling system comprises an audio interface 102, a microphone interface 104, and a positioning interface 106. The noise cancelling system 100 provides improved ambient noise reduction capabilities for users of the device.

The audio interface 102 may be attached to the housing 12. The audio interface 102 may be a device earpiece or speaker used during mobile telephone conversations, for example. However, any suitable audible interface may be provided.

The microphone interface 104 may be attached to the housing 12. The microphone interface 104 is configured to receive ambient noise signals. The microphone interface 104 may be a device microphone used during mobile telephone conversations, for example. However, any suitable interface configured to sense (or receive) noise/sounds may be provided. In an alternate embodiment the microphone interface may be may be attached to the housing proximate the audio interface, however any suitable location may be provided.

It should be noted that although the audio interface 102 and the microphone interface 104 are shown proximate a front face of the device 10, this location is not required. For example in one alternate embodiment, the audio interface and the microphone interface may be provided proximate a back face of the device. For example in another embodiment, the audio interface and the microphone interface may be provided proximate a side face of the device. Additionally, the audio interface and the microphone interface are not required to be proximate the same face of the device. For example, the audio interface may be provided on the front face of the device, while the microphone interface may be provided on the side face of the device. However, any suitable configuration may be provided.

The positioning interface 106 may be provided in the device 10. The positioning interface 106 may be a global positioning system (GPS) for example. However, any suitable positioning/navigation system may be provided.

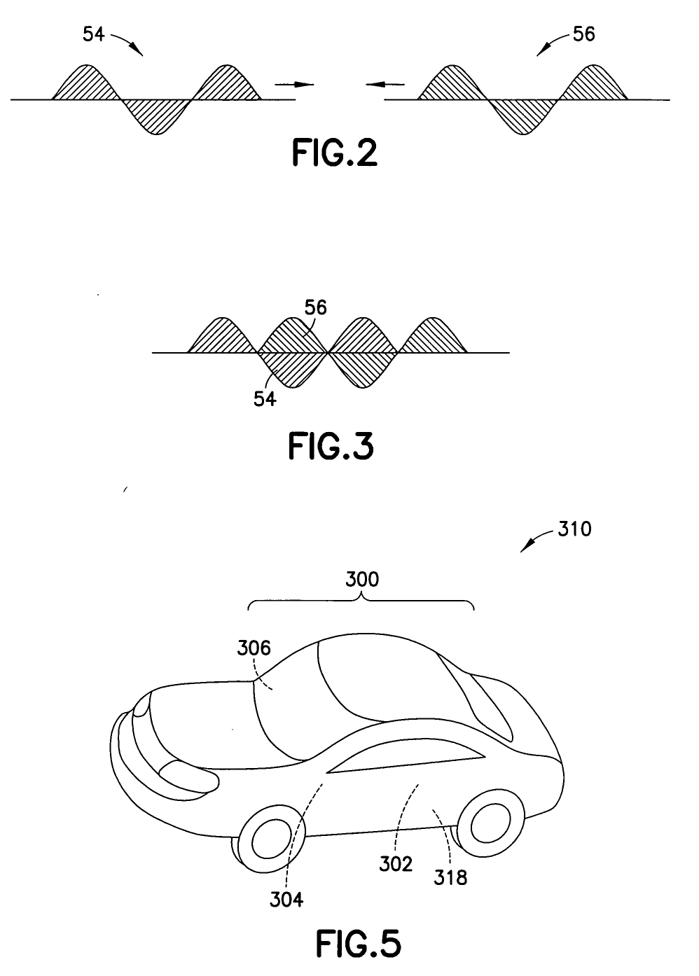

The noise cancelling system 100 may provide for improved noise reduction capabilities by utilizing information provided from the positioning interface 106. The noise cancelling system 100 may allow a user of the device 10 to be protected from excess noise, even in the event of non-continuous, but predictable, noise characteristics. For example, the user of the device 10 may be riding in a vehicle. While riding in the vehicle, ambient sounds such as an acceleration of the vehicle, or a change of pavement type that the vehicle is on, for example, may be heard throughout the vehicle interior. The noise cancelling system 100 is configured to use information (or signals) from the positioning interface 106 to determine these changes based on the location of the vehicle (as the user and the device 10 are in the vehicle). For example, the GPS navigation system 106 may determine a change in the speed (or acceleration) of the vehicle. The acceleration of the vehicle would provide increased ambient noise 50 (which may be perceived within the vehicle interior). This acceleration information (provided by the GPS system 106) would allow the noise cancelling system 100 to provide a noise cancelling output 52 at the audio interface 102 to cancel at least a part of the ambient (acceleration) noise 50. For example, FIGS. 2 and 3 illustrate a graphical view of a waveform 54 (which may correspond to the noise cancelling output 52, for example) and a graphical view of a waveform 56 (which may correspond to the ambient noise 50, for example). The noise cancelling system 100 produces the waveform 54 (noise cancelling output 52) with generally opposite polarity to that of the waveform 56 (ambient noise 50). As shown in FIG. 3, the two waveforms, or soundwaves, 54, 56 combine to substantially cancel each other out, and therefore reduce unwanted ambient noise.

The cancelling out of the waveforms (or signals) 54, 56 may be provided by analysis of the waveforms through the computer/processor of the device 10. For example, the waveform of the background ambient noise may be analyzed in order to generate a ‘reversed’ waveform for cancellation by interference. The generated waveform may have substantially the same (or proportional) amplitude to the waveform of the background ambient noise, but with a generally reversed polarity. This generated waveform, in combination with the waveform of the ambient noise provides a destructive interference that substantially reduces the amplitude of the background noise heard by the user of the device. It should be noted that the cancelling of the waveforms may be provided by any suitable technique such as, but not limited to, ‘reverse polarization’, ‘phase cancellation’, ‘antinoise’, or any other suitable noise cancelling/control techniques. However, any suitable noise cancelling technique may be provided.

The waveforms 54 provided by the noise cancelling system (as described above) may be stored as a noise profile in a memory of the device (or in a memory of the noise cancelling system). According to one embodiment of the invention, the device 10 may comprise various noise profiles in the memory of the device. Each noise profile may be specific to a vehicle, environment, location, and/or position. For example, one noise profile may correspond to the acceleration scenario (as described above), another noise profile may correspond to a ‘constant highway/freeway speed’ scenario. Additionally, the noise profiles (which may be route-specific sound histograms) may be provided for corresponding to typical sound patterns of the type of vehicle used during the route. However, these are merely provided as non-limiting examples, and any suitable noise profiles may be provided.

The noise cancelling system 100 may select the noise profile in response to context-based noise information provided by the GPS system 106. The context-based noise information may be, a signal indicating that the vehicle is accelerating, or a signal that the vehicle is traveling at a constant highway/freeway speed. However, these are merely examples, and any suitable context-based noise information may be provided.

The noise cancelling system 100 may also receive an indication from the GPS system 106 that a change in the ‘noise’ environment will be taking place (or that the change has occurred) wherein the microphone 104 may, for example, receive sounds to process the change in the noise environment. The sounds may be analyzed to be matched with stored noise profiles, or to create a new noise profile (wherein the noise cancelling system may provide waveforms based on received ambient sounds/noise from the microphone).

The microphone 104 may also provide a type of a feedback system for the noise cancelling system 100. For example, the microphone 104 may periodically or continuously (or at set intervals/events) monitor the ambient noise. The feedback system may be put in place in order to allow the noise cancelling system 100 to react quickly if the ambient noise does not change as expected. Additionally, the system may be provided a learning adaptive control system that improves the noise profiles through feedback the more it is used.

The noise cancelling system 100 may also use map information, which may be available from the GPS system 106 for example, to determine (and/or anticipate) a type of road the vehicle is being driven on. Additionally, the noise cancelling system 100 may use the map info to determine changes in speed limits (and thus anticipated acceleration(s)). The adaptation of the noise-cancelling algorithm (generated/provided by the noise cancelling system 100) is accelerated based on preliminary information of changes in various parameters that correlate with the rapid change of noise characteristics, for example a speed limit change from 50 to 100 km/h, or a change in pavement material. For example, the map information of the GPS navigation system may distinguish between unpaved roads, smooth pavement, gravel, or cobblestone roads. The road surface information may be provided as part of the context-based noise information provided from the GPS system to the noise cancelling system. As the GPS system (or positioning interface) 106 provides a signal to the noise cancelling system 100 indicating the location/environment change of the vehicle, this in turn allows a noise profile to be selected, which then provides sound waves similar to the “acceleration” example above. For example, the noise cancelling system may provide soundwaves corresponding to cancelling out noise from the vehicle riding on the different surfaces.

Additionally, although the examples above have been made with reference to traveling in a vehicle, examples of the invention may be provided while the user of the device is not in a vehicle, such as walking for example. The adaptive noise-cancelling system 100 may reduce ambient noise when walking into a hall of a power plant facility hall from outside of the building, or when walking into a crowded room for example.

According to some embodiments of the invention, the noise cancelling system 100 may also be configured to have network connectivity. This would allow the noise cancelling system 100 to be utilized with an optional network service configured to help with noise-cancelling on the road.

For example, typical sound patterns (or waveforms) for the type of vehicle used during the route may be received from a network service providing information per user basis or per car model basis. The typical sound patterns may also be provided for use in combination with route-specific sound histograms stored in the device. In another example, a change of weather conditions may also be obtainable through network interface. This would allow network information relating to a change from driving on a dry road to a wet road, for example, to be provided to the noise cancelling system 100. As wet roads may lead to different noise characteristics of the ambient noise, a modified waveform may be provided to accommodate for this.

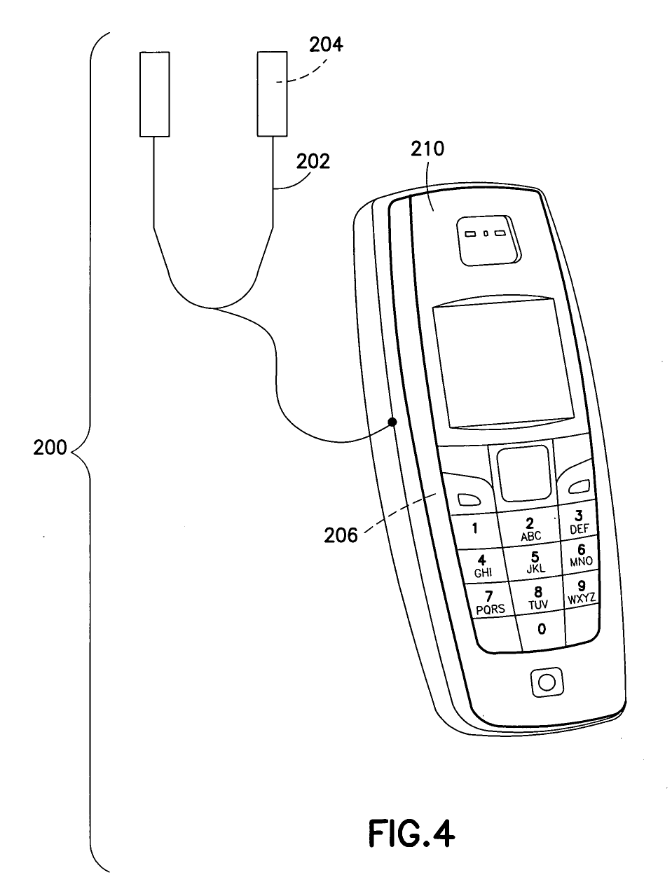

It should further be noted that the noise cancelling system 100 is not required to be provided within a mobile telephone as illustrated in FIG. 1. According to one embodiment of the invention, a noise cancelling system 200 may be provided with a headset 202 connected to a device 210 as shown in FIG. 4. The noise cancelling system 200 is similar to the noise cancelling system 100 and is configured, in a similar fashion as described above, to generate waveforms 54 for minimizing the ambient noise 56. The noise cancelling system 200 comprises an audio interface, a microphone interface, and a positioning interface. However, the noise cancelling system 200 provides the audio interface as a headset 202 connected to the device. The microphone interface 204 may also be provided at the headset. However, alternate embodiments may provide the microphone interface at the device similar to the noise cancelling system 100. Additionally, similar to the noise cancelling system 100, the positioning interface 206 may be any suitable positioning/navigation system, such as a GPS system for example. As described above, the noise cancelling system 200 may generate the waveforms 54, which may be stored as noise profiles in a memory of the device, and/or the noise cancelling system 200 may select the noise profile in response to context-based noise information provided by the GPS system 206.

Similar to the noise cancelling system 100 the noise cancelling system 200 may also provide for network connectivity (for downloadable location/route specific network services). The noise cancelling system 200 may have means for logging ambient noise characteristics to local and/or remote storage, and/or may utilise the context knowledge (e.g. position, time, or change in position, time) to cancel the noise more effectively during transitional periods from one context-dependent ambient noise environment to another. For example noise cancelling signals (or waveforms) may be provided (based at least in part on context-based noise information from the positioning interface) for acceleration noise, road surface noise, or walking environment/location ambient noise.

According to another embodiment of the invention, a noise cancelling system 300 may be provided within a vehicle 310. The noise cancelling system, or noise cancelling navigator, 300 is similar to the noise cancelling system 100, 200 and is configured, in a similar fashion as described above, to generate waveforms 54 for minimizing the perceived ambient noise 56. The noise cancelling system 300 comprises an audio interface 302, a microphone interface 304, and a positioning interface 306. According to some embodiments of the invention, the noise cancelling system 300 may be integrated within the vehicle 310 (see FIG. 5). For example, the audio interface 302 may be provided as vehicle audio system speakers. The microphone interface 304 may be mounted within the vehicle 310. The positioning interface 306 may be provided as a GPS car navigation system, for example. Additionally, the vehicle may comprise electronic circuitry 318, such as a controller and a memory for example, connected to the noise cancelling system 300. However, any suitable configuration may be provided. For example, in one alternate embodiment the noise cancelling system may be formed by connecting a portable device to a vehicle connection wherein the portable device is in communications with the vehicle components such as by a direct wire or Bluetooth® connection, for example. Once connected, the device may utilize one or more of the vehicle components to provide a noise cancelling system. As described above, the noise cancelling system 300 may generate the waveforms 54, which may be stored as noise profiles in a memory of the device, and/or the noise cancelling system 300 may select the noise profile in response to context-based noise information provided by the GPS system 306.

It should be understood that although the noise cancelling system 300 is described above with the audio system speakers as the audio interface, the microphone interface mounted within the vehicle, and the positioning interface as the car GPS navigation system, any suitable configuration for integrating the noise cancelling system may be provided. In addition, any suitable car/vehicle components may be utilized and/or modified for implementation of the noise cancelling system. For example, in one alternate embodiment, the car/vehicle stereo unit and/or loudspeakers may be provided for implementing the antinoise waveforms. For example in another embodiment, the car/vehicle stereo unit may comprise the microphone interface. However, these are merely examples and any suitable car/vehicle stereo unit capabilities may be utilized for providing the noise cancelling system.

According to some embodiments of the invention, the context-based noise information (and/or noise profile) may be used in volume control of the audio interface. For example, if a sudden increase in ambient noise volume is expected within about 5 seconds, the volume of the audio interface may also be increased after about 5 seconds, to ensure proper hearing of the audio content.

According to various exemplary embodiments of the invention, the noise cancelling system may also allow for the noise-cancelling algorithm to learn from history, by implementing a feedback of the noise-cancelling results (through the microphone interface), and adjusting algorithm parameters. For example, the noise history/profiles may be shared between similar vehicles (such as through a network service). Thus obtaining a set of location-based future noise profiles for different cars/users may be a community effort.

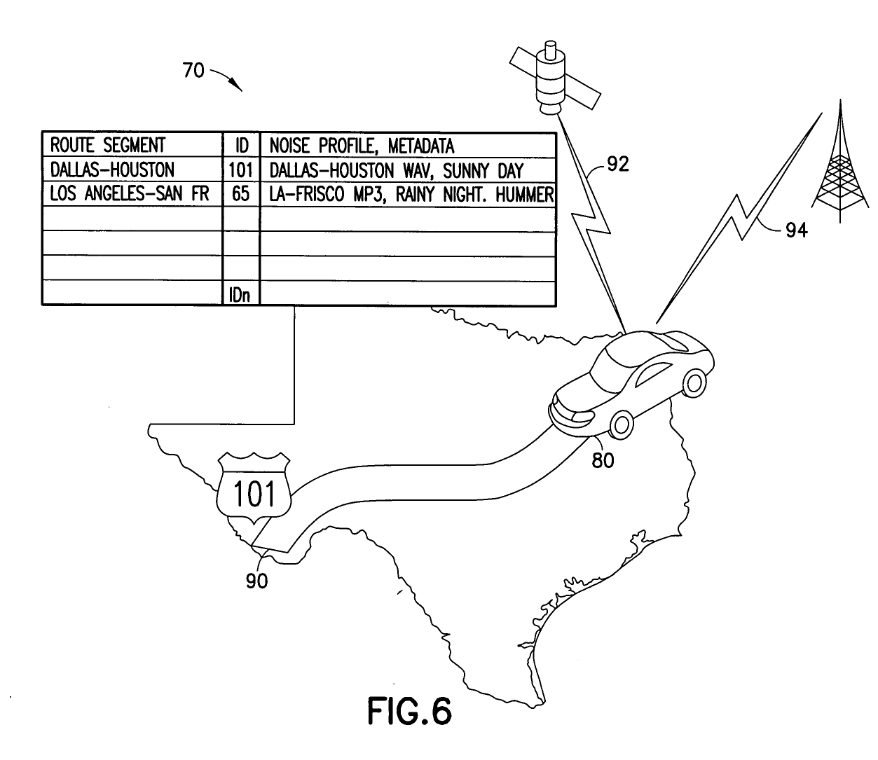

According to one example, as shown in FIG. 6, a first user of the noise cancelling system 100, 200, 300 may drive from a first location 80 to a second location 90 with a VW® Golf GTI, manufacturing year 1999, utilizing the noise cancelling system to receive the context-based noise information (through a GPS connection 92, for example) and sharing the noise history/profile for the route with the associated metadata 70 (such as, time of the year, weather conditions, etc.), through a connection 94 to a network service. If a second user of the noise cancelling system 100, 200, 300 then later drives the same route (or segments of it) with, for example, a VW® Golf GT, manufacturing year 1998, in similar weather conditions, the second user's noise-cancelling navigator may utilize the first user's noise profile/history for that route, in predicting the location-based future noise profiles of the second user. Furthermore, the second user may again store and/or share his/her noise profile/history measured for that route to a third user.

It should be noted that the references above made with respect to the VW® Golf are for exemplary purposes only, and that any suitable vehicle may be provided. It should also be noted that the GPS connection 92 may be any suitable connection between a device/vehicle and a navigation and/or positioning system. Additionally, the connection 94 to the network service may be any suitable type wireless communications connection.

According one embodiment of the invention, a network service/community may be provided to help build the noise-cancelling profiles. The noise profiles may provide noise cancelation waveforms for various scenarios and are not only limited to road navigation applications. For example, noise profiles may be provided (and made available for download through the network service) for sports event related ambient noise, such as motor sports, stadium sports, etc. Additionally, other noise profiles may be provided for shopping mall environments, school yard environments, etc. The noise profiles may be utilized in devices such as mp3 players, mobile tv handsets, portable computer devices, mobile telephone devices, or any other multimedia device which has speaker/headset configurations.

According to one example of the invention, the network service may receive a position signal from the noise cancelling system (such as through a wireless connection of the device, for example). The network service may then provide and/or generate a noise profile (comprising noise cancelling waveform information) based on the position signal. This noise profile could then be sent through the network connection (as a download service, for example) to the noise cancelling system. It should be noted that in alternate embodiments a user of the noise cancelling system may manually select the desired location/environment through the connection to the network service instead of providing the position signal.

Technical effects of any one or more of the exemplary embodiments provide for the user of the noise cancelling system 100, 200, 300 to be protected by excess noise even in the event of non-continuous, but predictable noise characteristics (such as acceleration, change of pavement type, change from dry to wet road, walking in a noisy hall, for example). As this kind of often happening events may be recorded and analysed (and predicted based on context) the noise-cancelling algorithm may be provided a prediction of the change of ambient noise in advance, for example about 5 seconds before the change is expected. After the about 5 seconds, the noise-cancelling system may start to produce waveforms that probably cancel at least a part of the noise.

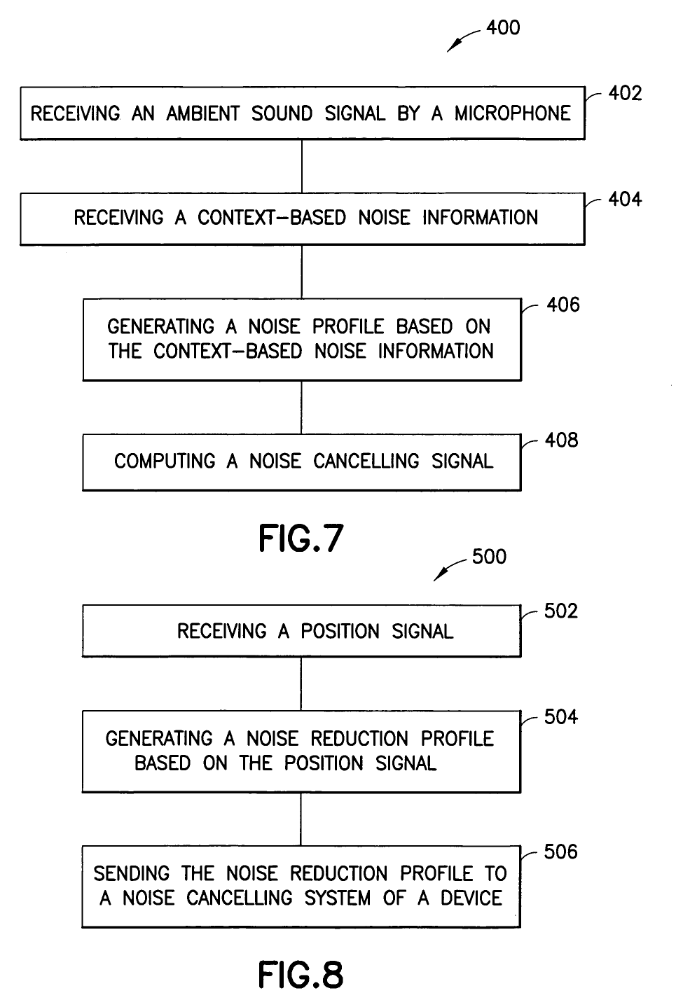

FIG. 7 illustrates a method 400. The method 400 includes the following steps. Receiving an ambient sound signal by a microphone (step 402). Receiving a context-based noise information (step 404). Generating a noise profile based on the context-based noise information (step 406). Computing a noise cancelling signal based, at least in part, on the ambient sound signal and the noise profile (step 408). It should be noted that any of the above steps may be performed alone or in combination with one or more of the steps.

FIG. 8 illustrates a method 500. The method 400 includes the following steps. Receiving a position signal (step 502). Generating a noise reduction profile based on the position signal (step 504). Sending the noise reduction profile to a noise cancelling system of a device (step 506). It should be noted that any of the above steps may be performed alone or in combination with one or more of the steps.

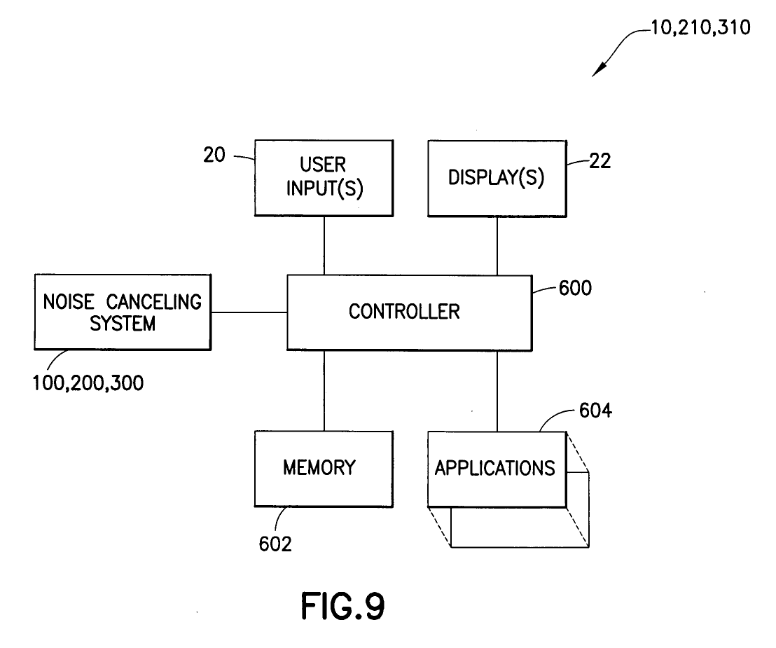

Referring now also to FIG. 9, the device 10, 210 (or vehicle 310) generally comprises a controller 600 such as a microprocessor for example. The electronic circuitry includes a memory 602 coupled to the controller 600, such as on a printed circuit board for example. The memory could include multiple memories including removable memory modules for example. The device has applications 604, such as software, which the user can use. The applications can include, for example, a telephone application, an Internet browsing application, a game playing application, a digital camera application, a map/gps application, etc. These are only some examples and should not be considered as limiting. One or more user inputs 20 are coupled to the controller 600 and one or more displays 22 are coupled to the controller 600. The noise cancelling system 100, 200, 300 is also coupled to the controller 600. The noise cancelling system 100, 200, 300 may programmed to automatically reduce ambient noise. However, in an alternate embodiment, this might not be automatic. The user may actively select a change of the noise cancelling system.

Conventional techniques to cancel ambient noise generally work for continuous, stable noise characteristics. However, these conventional techniques may be limited when it comes to noise changes due to accelerations, pavement changes, weather conditions, etc. Technical effects of any one or more of the exemplary embodiments provide for real-time techniques to cancel relatively fast changes in noise characteristics, and further configured to be an adaptive noise-cancelling system which can re-adapt if the noise characteristics change.

Additionally, the technical effects of any one or more of the exemplary embodiments provide for suppressing in-vehicle noise by predictive, adaptive noise cancelling and a community-based effort to save noise history/profile (such as, per car model) through a network service, for example (wherein the system may learn to adapt to personal driving preferences). Further, data mining the noise history databases may provide information on such parameters as pavement condition, true noise levels of specific car models, driving habits in different parts or roads in the location/area.

According to one example of the invention, an apparatus is disclosed. The apparatus includes electronic circuitry and a noise cancelling system. The noise cancelling system is connected to the electronic circuitry. The noise cancelling system includes a positioning interface. The noise cancelling system is configured to provide a noise cancelling signal based on, at least partially, the positioning interface.

According to another example of the invention a program storage device readable by a machine, tangibly embodying a program of instructions executable by the machine for performing operations to adaptively reduce noise is disclosed. A position signal is received. A noise reduction profile is generated based on the position signal. The noise reduction profile is sent to a noise cancelling system.

It should be understood that components of the invention can be operationally coupled or connected and that any number or combination of intervening elements can exist (including no intervening elements). The connections can be direct or indirect and additionally there can merely be a functional relationship between components.

It should be understood that the foregoing description is only illustrative of the invention. Various alternatives and modifications can be devised by those skilled in the art without departing from the invention. Accordingly, the invention is intended to embrace all such alternatives, modifications and variances which fall within the scope of the appended claims.

What is claimed is:

1. An apparatus comprising electronic circuitry and a noise cancelling system connected to the electronic circuitry, wherein the noise cancelling system comprises a positioning interface, and wherein the noise cancelling system is configured to provide a noise cancelling signal based on, at least partially, the positioning interface.

2. An apparatus as in claim 1 wherein the noise cancelling system further comprises a microphone and an audio interface.

3. An apparatus as in claim 2 wherein the microphone is proximate the audio interface, and wherein the microphone is configured to receive an ambient sound signal.

4. An apparatus as in claim 2 wherein the noise canceling system is configured to adjust a volume of the audio interface based on, at least partially, the positioning interface.

5. An apparatus as in claim 2 wherein the noise cancelling system further comprises a feedback system, and wherein the feedback system is configured to receive a signal from the microphone.

6. An apparatus as in claim 1 wherein the positioning interface comprises a global positioning system (GPS).

7. An apparatus as in claim 1 wherein the apparatus further comprises a network interface, and wherein the apparatus is configured to receive a noise profile from a network service through the network interface.

8. An apparatus as in claim 7 wherein the noise cancelling system is configured to provide a noise cancelling signal based on, at least partially, the noise profile.

9. An apparatus as in claim 1 further comprising a head set interface, wherein the noise cancelling system is configured to provide the noise cancelling signal through the head set interface.

10. An apparatus as in claim 1 wherein the apparatus is a mobile electronic device.

11. A method comprising:
receiving an ambient sound signal by a microphone;
receiving a context-based noise information;
generating a noise profile based on the context-based noise information; and
computing a noise cancelling signal based, at least in part, on the ambient sound signal and the noise profile.

12. A method as in claim 11 wherein the receiving of the context-based noise information comprises receiving the context-based noise information from a GPS system.

13. A method as in claim 11 wherein the generating of the noise profile further comprises retrieving a noise profile from a memory.

14. A method comprising:
receiving a position signal;
generating a noise reduction profile based on the position signal; and
sending the noise reduction profile to a noise cancelling system of a device.

15. A method as in claim 14 wherein the receiving of the position signal further comprises receiving a signal from a positioning system.

16. A method as in claim 14 wherein the receiving of the position signal further comprises a user selecting a position.

17. A method as in claim 14 wherein the sending of the noise reduction profile further comprises sending the noise reduction profile from a network service to a portable device through a network connection.

18. A program storage device readable by a machine, tangibly embodying a program of instructions executable by the machine for performing operations to adaptively reduce noise, the operations comprising:
receiving a position signal;
generating a noise reduction profile based on the position signal; and
sending the noise reduction profile to a noise cancelling system.

19. A program storage device as in claim 18 further comprising providing a noise canceling waveform at an audio interface of a device.

20. A program storage device as in claim 18 wherein the receiving of the position signal further comprises receiving context-based noise information.
